(19) United States
(12) Patent Application Publication
(10) Pub. No.: US 2023/0359782 A1
(43) Pub. Date: Nov. 9, 2023

(54) FRESHWATER AND SALTWATER MAPS HAVING SELECTABLE WATER CURRENT FLOW MODELING DISPLAYABLE THEREWITH

(71) Applicants: William Mark Gibson, Eufaula, AL (US); Taylor Clark, Dahlonega, GA (US); Thomas Joseph Schultz, Cushing, MN (US); Kevin Maxime Maingault, Arue (PF)

(72) Inventors: William Mark Gibson, Eufaula, AL (US); Taylor Clark, Dahlonega, GA (US); Thomas Joseph Schultz, Cushing, MN (US); Kevin Maxime Maingault, Arue (PF)

(73) Assignee: Johnson Outdoors Inc., Racine, WI (US)

(21) Appl. No.: 17/738,901

(22) Filed: May 6, 2022

(51) Int. Cl. G06F 30/20; A01K 97/00

(52) U.S. Cl. CPC G06F 30/20; A01K 97/00; G01C 13/002

(57) ABSTRACT

A method of making and a computer readable media having data readable by a fish finder are provided. The data includes a topographical fishing map usable by the fish finder to display bathymetric information regarding a body of water, and a number of water current flow simulations. Any of the number of simulations is selectable via the user input and usable by the fish finder to display water current flow as a layer on the bathymetric information regarding a body of water. Freshwater currents or saltwater tides may be provided in certain embodiments. The method includes inputting the bathymetric information from the topographical fishing map and current flow conditions to the processor, processing a hydrodynamic or tidal modeling program and storing the water current flow simulation as a user selectable layer on the media on which the topographical fishing map is stored.

### FIELD OF THE INVENTION

This invention generally relates to cartography and bathymetry for bodies of water, and more particularly to freshwater and saltwater fishing maps providing anglers with detailed information to enhance the fishing experience.

### BACKGROUND OF THE INVENTION

It is reported that nearly 55 million people went fishing in the United States alone in 2020, driving $51 billion in retail sales, $129 billion in economic impact, and providing over 800,000 jobs. To make such experiences more enjoyable for the everyday angler or weekend warrior, whether in saltwater or freshwater, the assignee of the instant application provides detailed fishing charts that provide accurate and innovative, one-of-a-kind features anglers need to eliminate unproductive water and find the best fishing spots faster to make the most of every fishing day.

Based on freshwater data collected by the assignee of the instant application by their own GIS survey crew who spend tireless hours mapping year-round, and from the National Oceanic and Atmospheric Administration (NOAA), the most-trusted saltwater source, these accurate charts and maps provide modern anglers with a clear view of underwater terrain. Such charts and maps allow the angler to identify buoys, daymarkers, hazards, marinas and countless other navigation aids and points of interest with a comprehensive icon system, as well as to see depth contours and spot soundings for coastal areas. High-definition charts and maps provide highly accurate 1′-3′ depth contour maps, providing anglers with detail that allow productive decision making on where to fish.

Recognizing that anglers may also fish on private lakes or other bodies of water for which commercial maps and charts are not available, the assignee of the instant application provides an AutoChart Live™ product that enables the angler to build richly detailed maps of these favorite fishing spots in real-time. Such system allows the angler to map the water as they drive their boat around the body of water. Once the map is live, the angler may view it with vegetation, bottom hardness and depth contours to locate the best fish-holding areas.

With the available digital charting from the assignee, an angler is able to select and highlight a particular depth range, so the angler can easily target productive water and stay in the bite zone. Such digital charts and maps allow easy-to-see shading highlights for shallow water areas on an adjustable range from 0 to 60 feet, making it easier to spot flats and reefs for shallow water fishing. Depth highlighting is also available from 0 to 1,000 feet on raster maps and 0 to 18,000 feet for vector (VX) charts. These digital maps and charts also allow synchronization of the depth contours and shorelines with the actual water levels of lakes, reservoirs and rivers to provide accurate data for planning the fishing experience based on present conditions.

Indeed, with innovative algorithms proprietary to the assignee's SmartStrike™ product, the angler is shown where the fish should be biting at any given moment. Based on search parameters like season, time of day, temperature and targeted fish species, SmartStrike™ highlights areas of the lake map where the angler's prey is most likely to be located. Such a system removes guessing, fruitless searching, or folding paper maps, and allows the angler just to fish. More specifically, SmartStrike™ is a fish location prediction software which works in conjunction with Lakemaster® cartography in order to give likely species specific locations of fish as they relate to the bathymetry and other factors of a lake. Using algorithms which incorporate elements such as known species behavior and merging them with other influences such as time of year and day, sky condition, wind, water clarity, depth, slope, sun exposure and aspect, points, humps, ledges, inlets, and other features the software will highlight areas over the Lakemaster® map that have a higher probability of holding the target species.

Despite all of the advances enabled by such digital charts and maps for the modern angler, the unique water flow of currents in freshwater rivers, reservoirs, and lakes, as well as near coastal or open ocean currents has long been one of the most closely guarded secrets of top anglers to enable them to bring home a day's catch or to win the big tournament.

Despite the usefulness and productivity of this Holy Grail of fishing data, currently, coastal fishing maps have had only very rudimentary current displays to indicate direction and speed for only about 2,500 locations across the United States. Perhaps more disappointingly, there has never been an attempt to cater anything of this type towards the freshwater angler.

Currently, only sparse single point arrow-of-direction and speed of current is available to be displayed on a map. To see a bit more information an angler can open the current station overview, which will display a graph of speed and direction for that day. Current and tidal predictions are typically created by government organizations such as NOAA because of the complexity and cost at their base level. The government will then offer the predictions as a list or database file for so many months or years in advance to the public, e.g. two years in the case of NOAA. Government agencies may also occasionally offer software containing the base algorithms and constituents to predict such data out further. Indeed, such predictions of current flow is expensive and difficult to create, which is why government organizations are typically the only ones that have dedicated the resources necessary to generate such data.

What is needed is a system and method to open the mystery of currents from those who have spent a lifetime of experience on the water learning their relationships to the general angler who may not have the time to spend hundreds of days on the water each year. Embodiments of the present invention provide such systems and methods to illustrate currents and/or how fish relate to them by creating a unique, dynamic, and easy to understand visualization of water currents to the angler.

These and other advantages of the invention, as well as additional inventive features, will be apparent from the description of embodiments of the invention provided herein.

### BRIEF SUMMARY OF THE INVENTION

In one aspect, embodiments of the present invention provide new and improved fishing maps that provide anglers with information to enable better understanding of the aquatic environment as it relates to current flow. More specifically, embodiments of the present invention provide new and improved fishing maps that provide anglers with water current data as a layer that may be displayed with their fishing maps. Still more specifically, embodiments of the present invention provide new and improved fishing maps that provide anglers with water current data as a simulation layer that may be displayed with their fishing maps at different water current flow conditions or times.

In embodiments of the present invention, systems and methods for providing freshwater and coastal currents as a visually rich display for freshwater and coastal maps and charts for the recreational angler are provided. Such visually rich display provides a revolution in mapping of fish behavior and why they are located in specific and unique locations in such freshwater and coastal areas that may otherwise not be understood from topographic information or the body of water alone.

In certain embodiments the systems and methods of the present invention provide a visual display of current flows, eddies, and backflows of water which are crucial to the predator/bait relationship.

In embodiments of the present invention, the systems and methods input this current flow data into predictive fishing related algorithms, e.g. SmartStrike™, to further refine fish location behavior and to display these areas to the angler.

In other embodiments of the present invention, the systems and methods provide wind driven modifications to current beyond the standard water flow. In some embodiments live wind updates are pushed through a provided app to refine and increase accuracy of the data. Seiche effect of wind pushing water to one end of a lake and the inherent currents derived from it are also provided in other embodiments of the present invention.

Certain embodiments of the present invention provide three-dimensional (3D) display of currents, in addition to the top down two-dimensional (2D) display of currents provided in some embodiments. Such 3D embodiments display how the current interacts under water at different depths and as it relates to the underwater structures, such as humps or rocky outcrops, etc.

In an embodiment of the present invention, a non-transitory computer readable media that has stored thereon data readable by a fish finder is provided. The fish finder has a display and user input. The data includes a topographical fishing map usable by the fish finder to display bathymetric information regarding a body of water, and a number of water current flow simulations. Any of the simulations is selectable via the user input and usable by the fish finder to display water current flow on the bathymetric information regarding a body of water.

In one embodiment, the plurality of water current flow simulations includes a first water current flow simulation illustrating a first flow condition for the body of water and a second water current flow simulation illustrating a second flow condition for the body of water that is different than the first flow condition for the body of water. In some embodiments the water current flow simulations include a third water current flow simulation illustrating a third flow condition for the body of water different than the first flow condition and the second flow condition for the body of water. Preferably, the first flow condition is a nominal inflow/outflow rate, the second flow condition is a high inflow/outflow rate greater than the nominal inflow/outflow rate, and the third flow condition is a low inflow/outflow rate less than the nominal inflow/outflow rate.

In another embodiment the first flow condition for the body of water is a first tidal current condition at a first time, and the second flow condition for the body of water is a second tidal current condition at a second time. In an embodiment the first tidal current condition at the first time corresponds to high tide, and the second tidal current condition at the second time corresponds to low tide.

In certain embodiments, the plurality of water current flow simulations includes current flow simulation data usable by the fish finder to display water current flow as a dynamic layer having current flow lines that move to show direction and rate of the water current flow. In other embodiments, the plurality of water current flow simulations includes current flow simulation data usable by the fish finder to display water current flow as a static layer having static flow arrows that are sized and positioned to point in a direction of the water current flow and to signify a rate of the water current flow. In embodiments the plurality of water current flow simulations includes current flow simulation data usable by the fish finder to display water current flow having colorizations to show rates of the water current flow.

In certain embodiments the non-transitory computer readable media is one of a secure digital (SD) card, microSD card, SDHC (high capacity) card, or SDXC (extended capacity) card, and in other embodiments, internal memory of the fish finder.

In an embodiment of the present invention, the water current flow simulations are generated by a processor running a hydrodynamic modeling program and using the topographical fishing map bathymetric information and selected inflow/outflow data for the body of water. In one embodiment the hydrodynamic modeling program is Delft3D-FLOW, although in other embodiments other commercial or custom hydrodynamic modeling programs may be used. In certain embodiments the selected inflow/outflow data is provided by one of NOAA, USGS, Army Corp of Engineers, other government agencies or private entities, monitoring stations, or user input.

In another embodiment, the plurality of water current flow simulations are generated by a processor running a tidal modeling program and using the topographical fishing map bathymetric information and selected time data for the body of water. In one embodiment the tidal modeling program is OTIS.

In an embodiment, the water current flow simulation is stored as a separate layer from the bathymetric information of the topographical fishing map that may be turned on or off by the user input. In an alternate embodiment, the water current flow simulation is integrated with the bathymetric information of the topographical fishing map. For vector (VX) maps the water current flow simulation data is wrapped into one set of master files.

In certain embodiments, the water current flow simulation is stored on a first media portion, and the bathymetric information of the topographical fishing map is stored on a second media portion. In one such embodiment, the first media portion is one of a secure digital (SD) card, microSD card, SDHC (high capacity) card, or SDXC (extended capacity) card, and the second media portion is internal memory of the fish finder.

In an embodiment of the present invention, a method of making a non-transitory computer readable media is provided. The media of this embodiment has stored thereon data readable by a fish finder having a display and user input. The data includes a topographical fishing map usable by the fish finder to display bathymetric information regarding a body of water, and at least one water current flow simulation selectable via the user input and usable by the fish finder to display water current flow as a layer on the bathymetric information regarding a body of water. In an embodiment wherein the fish finder includes topographical maps embedded therein, the media may include just the at least one simulation that may be used for display by the fish finder with or without the embedded topographical map.

In one embodiment the method includes inputting the bathymetric information regarding the body of water from the topographical fishing map to a processor, inputting at least one current flow condition to the processor. The method also includes processing, by the processor, a hydrodynamic modeling program to generate the at least one water current flow simulation corresponding to the at least one current flow condition, and storing the at least one water current flow simulations as user selectable layers on the non-transitory computer readable media on which the topographical fishing map is stored.

In an embodiment, the processor is a processor of the fish finder. Also in an embodiment, the step of processing occurs in real time as the bathymetric information regarding the body of water occurs.

In another embodiment of the present invention, a method of making a non-transitory computer readable media is provided. In this embodiment the media has stored thereon data readable by a fish finder having a display and user input. The data includes a topographical fishing map usable by the fish finder to display bathymetric information regarding a body of water, and a plurality of water current flow simulations selectable via the user input and usable by the fish finder to display water current flow as a layer on the bathymetric information regarding a body of water. The method of this embodiment includes inputting the bathymetric information regarding the body of water from the topographical fishing map to a processor and inputting a plurality of time conditions to the processor. The method also includes processing, by the processor, a tidal current modeling program to generate the plurality of water current flow simulations corresponding to the plurality of time conditions, and storing the plurality of water current flow simulations as user selectable layers on the non-transitory computer readable media on which the topographical fishing map is stored. In an embodiment wherein the fish finder includes topographical maps embedded therein, the media may include just the at least one simulation that may be used for display by the fish finder with or without the embedded topographical map.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified process flow diagram illustrating an embodiment of the method of the present invention for generating the fishing map computer readable cards having water current flow simulations available as viable layers thereon at user selectable conditions;

FIG. 2 is a pictorial illustration of a topographical map of a freshwater body of water showing freshwater current flow at a selected flow condition as a layer thereon in accordance with an embodiment of the present invention;

FIG. 3 is a pictorial illustration of a topographical map of a freshwater body of water showing freshwater current flow at a selected flow condition as a layer thereon in accordance with an alternate embodiment of the present invention;

FIG. 4 is a pictorial illustration of a topographical map of a saltwater coastal body of water showing saltwater current flow at a selected time as a layer thereon in accordance with an embodiment of the present invention; and

FIG. 5 is a pictorial illustration of a topographical map of a saltwater coastal body of water showing saltwater current flow at a selected time as a layer thereon in accordance with an alternate embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there are illustrated a simplified process flow diagram and exemplary freshwater and saltwater topographical maps having selectable water current flow modeling simulations displayable therewith in accordance with various embodiments of the present invention. However, it should be noted that such illustrations are provided simply to aid in the understanding by those of ordinary skill in the art of various embodiments of the present invention, and not to limit the scope of the claimed invention in any way. Indeed, the included figures and following description should be taken by way of example and not by way of limitation.

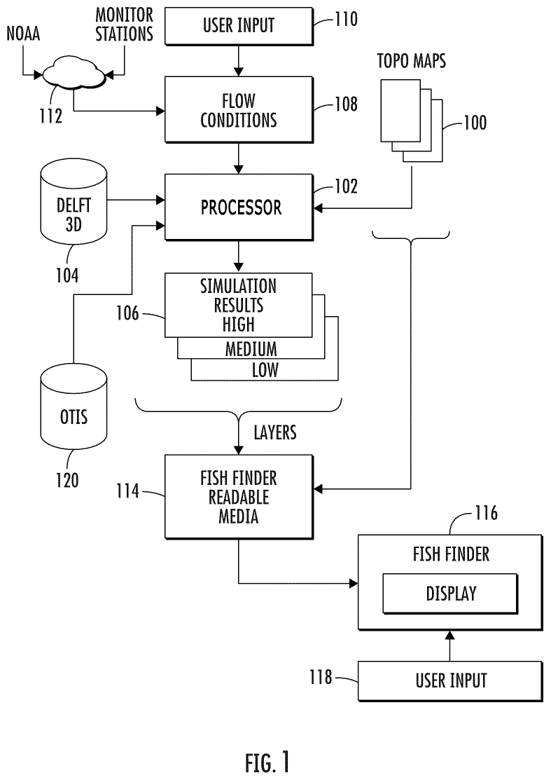

As shown in FIG. 1, the topographical fishing maps 100 are used by a processor 102 running the DELFT3D suite of open-source programs 104, and more particularly the Delft3D-FLOW program version 6.00.00 and FLOW-GUI version 3.43.05, created by a company in the Netherlands called DELTARES. This program 104 is used to generate the water current flow simulations 106 for the bodies of water represented by the particular topographical fishing maps 100.

In one embodiment, the processor is an AMD Athlon 64 X2 Dual Core Processor 4200+, 2.19 GHz, in either a Windows or Linux PC or workstation, with or without Domain decomposition, that also may or may not include separate I/O-processors. However, other embodiments may use other processors and operating systems for generating the simulation, e.g. the processor in the head unit of the fish finder itself in embodiments wherein the simulation is generated onboard and/or in real time. Such embodiments are particularly beneficial to enable use of existing topographic map cards that do not include such simulations stored thereon and having the fishfinder generate and display the simulation on the display, with or without the topo map from the card. Such an embodiment is also beneficial for fish finders that generate the topo map in real time by using a program such as AutoChart® Live available from the assignee of the instant application, or that stream topo map or other bathymetric data from an external source.

In yet other embodiments, the processing is done on a remote server/processor, previously or in real time, and then streamed via a smartphone, app, WiFi, satellite data service, etc. Such embodiments are also particularly beneficial to enable use of existing topographic map cards that do not include such simulations stored thereon and having the fishfinder display the simulation on the display, with or without the topo map from the card. Such an embodiment is also beneficial for fish finders that generate the topo map in real time by using a program such as AutoChart® Live available from the assignee of the instant application, or that stream topo map or other bathymetric data from an external source, which may be the same or a different source than from which the current simulation is obtained.

As those skilled in the art are aware, DELTARES specializes in hydrodynamic modeling, typically for government research of flood inundation, storm surges, and economic impacts. As described in the Delft3D User Manual, Version 3.15 (9 Dec. 2021), the teachings and disclosure of which are herein incorporated in their entireties by reference thereto, “Delft3D-FLOW is a multi-dimensional (2D or 3D) hydrodynamic (and transport) simulation program which calculates non-steady flow and transport phenomena that result from tidal and meteorological forcing on a rectilinear or a curvilinear, boundary fitted grid.”

In addition to the use of the topographical fishing maps 100, e.g. Lakemaster® HD bathymetry data, that are input into the program 104, the process also inputs flow conditions 108, i.e. inflow and outflow data, for the body of water in order to create the realistic simulation of water flow currents in the body of water of the maps 100. Such flow or other conditions may be input from the user 110 and/or obtained from the internet or other network 112 via external sources of flow data such as NOAA, USGS, Army Corp of Engineers, other government agencies or private entities, monitoring stations, published hydraulic monitoring stations, etc.

Indeed, in certain embodiments of the present invention, multiple simulations 106 for many different scenarios involving various inflow/outflow, water level, rain, wind, and other factors are modeled using the processor 102 to create each unique situation. In a particular embodiment, simulations are run for high flow, normal flow, and low flow conditions for the particular body of water to provide the angler with a variety of current flow simulations 106 from which to choose that most closely matches the current conditions on the body of water on which the angler will be fishing. More or fewer simulations 106 based on the various factors that affect such may be provided to increase the likelihood of a close match to current conditions on the particular body of water, or to increase usability and decrease complexity and cost in other embodiments.

These simulations 106 are stored on a computer readable media 114, e.g. a secure digital (SD) card, microSD card, SDHC (high capacity) card, SDXC (extended capacity) card, etc., that can be used by the angler's fish finder 116, such as SOLIX®, APEX™, HELIX® fish finders available from the assignee of the instant application, to display both the topographical information of the body of water and/or the current flow simulation. In other embodiments, the computer readable media 114 on which the topographic fishing maps 100 and/or the current simulation(s) are stored for use by the fish finder 116 may be included in the fish finder 116 during manufacture or updating thereof. Indeed, for embodiments in which the fish finder includes embedded topographic fishing maps or that receive such from a streaming service, the card may include only the simulations for use by the fish finder to be displayed with the topographical fishing maps stored in the fish finder 116. In embodiments that provide multiple simulation results 106 for each body of water, the angler is able to select via user input 118 the simulation that most closely matches that day's conditions.

In certain embodiments, the simulations are provided as user selectable layers that may be turned on and off for display with the topographical information of the map. As will be recognized by those skilled in the art from the foregoing, the use of the term “layers” comes from the physical world but has been adopted for use in the world of digital graphics. That is, digital graphics such as maps use overlapping “layers” to associate different levels of data, allowing them to contribute to the overall complete display while maintaining separate identities. While the use of such digital layers provides advantages in certain embodiments, such as being able to turn the simulation on or off for display with or without the map, independently filtered, transformed, masked, or multiplied, the water current simulations may also be integrated with the map data in a manner that does maintain them as a separate “layer.” As such, as used herein, “layer” means both a separable digital graphic layer that may be turned on and off for display on the fish finder with or without the map, independently filtered, transformed, masked, or multiplied, as well as integration of the simulation with the map data in a manner that does not permit the simulation to be turned on and off, independently filtered, transformed, masked, or multiplied.

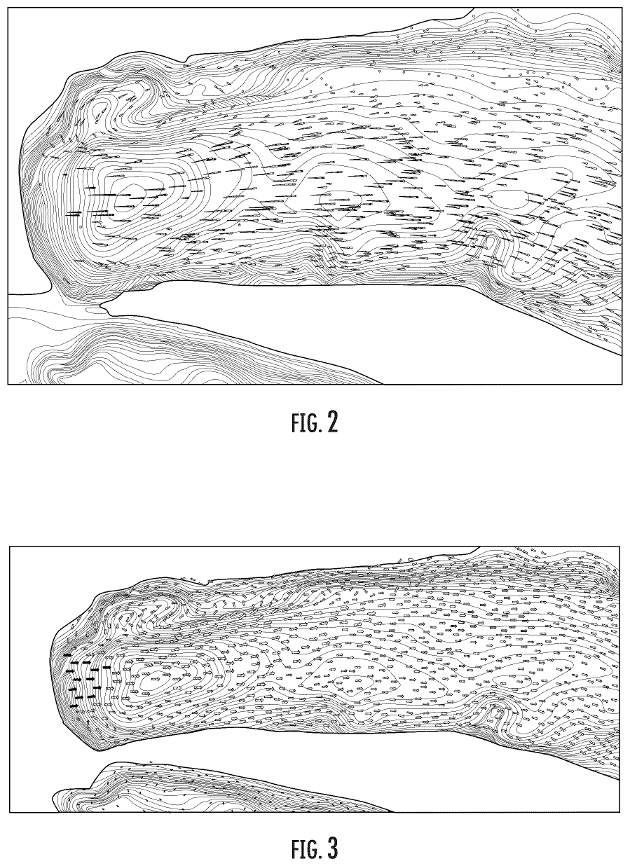

FIG. 2 illustrates a screenshot of a Lakemaster® map topographical display of a freshwater body including a current flow simulation layer displayed thereon. In the actual rich dynamic display of an actual fish finder 116, the current flow lines move to show the direction and rate of the current flowing, the eddies and backflows formed by the structures on the map, etc.

FIG. 3 illustrates a screenshot of a Lakemaster® map topographical display of a freshwater body including an alternate embodiment of the current flow simulation layer displayed thereon. In this embodiment, the simulation is not a rich dynamic display that utilizes moving current flow indications, but instead includes static flow arrows that are sized and point in the direction of the current to signify the direction and rate of the current flowing, the eddies and backflows formed by the structures on the map, etc. Such an embodiment utilizes less processing power of the fish finder 116.

In another embodiment the current flow, whether rich dynamic or static simulations, also includes colorization, user configurable or fixed, to provide a visual indication for flow rate. As an example in one embodiment, a red shading is used in the simulation layer to indicate rapid current flow, e.g. through a narrowing of the body of water.

As discussed above, current flow magnitude, speed, direction, and eddies will play a major role in the location of fish. As such, once the current flow simulations are completed, and upon user selection or automatically, the current flow simulation data is integrated into a predictive fishing program, e.g. the SmartStrike™ product available from the assignee of the instant application for use by its algorithms. In one embodiment such data is used by performing a search of the current vector or grid data for the simulation being used at that time. The program performs a number of search radii from each current vector or grid cell. Based on this search, the program identifies how many other cells had a directional change of a user selected or predetermined number of degrees, along with changes in speed.

Alternatively, or additionally, the program looks for similar current directions and flow magnitudes to those where a known fish species was caught to identify other areas with similar current directions and flow magnitudes. If the query identifies cells and areas which match the behavior of the chosen fish species, then such information is added as a variable in the predictive algorithm and weighted with the other possible influences for that fish species. Once the data has been considered, the program returns likely locations for that species to be found on the map given the input components.

While the foregoing embodiments utilized the Delft3D-Flow program 104 for the freshwater bodies of water, other embodiments of the present invention utilize topographical fishing maps 100, e.g. Coastmaster® marine charts, that cover costal saltwater areas. Because costal saltwater areas experience tidal activity, the processor 102 utilizes a base modeling system known as the Oregon State University Tidal Inversion Software (OTIS) for the areas represented by the maps 100. The output simulations 106 represent the current flow at different times during the day as a result of tidal activity. In one embodiment discrete times of high and low tide are modeled so as to provide the user selectable simulation result 106 that most closely matches the time and day during which the angler is fishing or will be fishing.

For the saltwater simulations 106, when included in the fish finder readable media 114, a set of constituents are produced for each location on the map 100 for which a dynamic current arrow will be displayed, and will be stored on the media 114, e.g. an SD card. The fish finder will then read that data to display the individual days, hours, or minutes prediction. The constituents in this context are all of the rules, data, and algorithms that are based on the rotation of earth and its orbit around the sun, the moon around the planet, as well as other factors such as the turbulent drag that is inherently created by the topography of the seafloor.

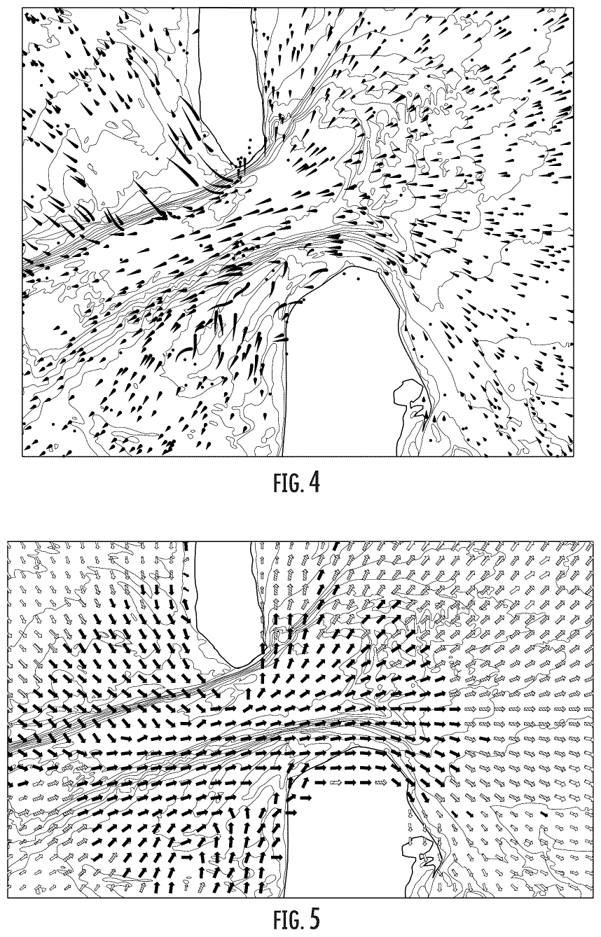

FIG. 4 illustrates a screenshot of a Coastmaster® map topographical display of a saltwater coastal body including a tidal current flow simulation layer displayed thereon at a particular day and time. In the actual rich dynamic display of an actual fish finder 116, the current flow lines move to show the direction and rate of the current flowing, the eddies and backflows formed by the structures on the map, etc.

FIG. 5 illustrates a screenshot of a Coastmaster® map topographical display of a saltwater coastal body including an alternate embodiment of the tidal current flow simulation layer displayed thereon. In this embodiment, the simulation is not a rich dynamic display that utilizes moving tidal current flow indications, but instead includes static flow arrows that are sized and point in the direction of the tidal current to signify the direction and rate of the current flowing, the eddies and backflows formed by the structures on the map, etc. Such an embodiment utilizes less processing power of the fish finder 116.

In another embodiment the tidal current flow, whether rich dynamic or static simulations, also includes colorization, user configurable or fixed, to provide a visual indication for flow rate. As an example in one embodiment, a red shading is used in the simulation layer to indicate rapid current flow, e.g. through a narrowing of the body of water.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. For example, other current flow and tidal modeling programs besides the Delft3D suite and OTIS may be used to create the simulations used in other embodiments. Additionally, other fish finders that the SOLIX®, APEX™, HELIX® fish finders available from the assignee of the instant application may be used, including mapping, navigation, and/or fish finding apps installed on a portable device, all of which are included in the term “fish finder” as used herein. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A non-transitory computer readable media having stored thereon data readable by a fish finder having a display and user input, the data comprising:
a topographical fishing map usable by the fish finder to display bathymetric information regarding a body of water; and
a water current flow simulation usable by the fish finder to display water current flow on the bathymetric information regarding a body of water.

2. The non-transitory computer readable media of claim 1, wherein the water current flow simulation includes a plurality of water current flow simulations selectable via the user input and, including a first water current flow simulation illustrating a first flow condition for the body of water, a second water current flow simulation illustrating a second flow condition for the body of water different than the first flow condition for the body of water.

3. The non-transitory computer readable media of claim 2, wherein the plurality of water current flow simulations includes a third water current flow simulation illustrating a third flow condition for the body of water different than the first flow condition for the body of water and the second flow condition for the body of water.

4. The non-transitory computer readable media of claim 3, wherein the first flow condition for the body of water is a nominal inflow/outflow rate, wherein the second flow condition for the body of water is a high inflow/outflow rate greater than the nominal inflow/outflow rate, and wherein the third flow condition for the body of water is a low inflow/outflow rate less than the nominal inflow/outflow rate.

5. The non-transitory computer readable media of claim 2, wherein the first flow condition for the body of water is a nominal inflow/outflow rate, and wherein the second flow condition for the body of water is a high inflow/outflow rate greater than the nominal inflow/outflow rate.

6. The non-transitory computer readable media of claim 2, wherein the first flow condition for the body of water is a nominal inflow/outflow rate, and wherein the second flow condition for the body of water is a low inflow/outflow rate less than the nominal inflow/outflow rate.

7. The non-transitory computer readable media of claim 2, wherein the first flow condition for the body of water is a first tidal current condition at a first time, and wherein the second flow condition for the body of water is a second tidal current condition at a second time.

8. The non-transitory computer readable media of claim 7, wherein the first tidal current condition at the first time corresponds to high tide, and wherein the second tidal current condition at the second time corresponds to low tide.

9. The non-transitory computer readable media of claim 1, wherein the water current flow simulation includes current flow simulation data usable by the fish finder to display water current flow dynamically having current flow lines that move to show direction and rate of the water current flow.

10. The non-transitory computer readable media of claim 1, wherein the water current flow simulation includes current flow simulation data usable by the fish finder to display water current flow statically having static flow arrows that are sized and positioned to point in a direction of the water current flow and to signify a rate of the water current flow.

11. The non-transitory computer readable media of claim 1, wherein the water current flow simulation includes current flow simulation data usable by the fish finder to display water current flow having colorizations to show rates of the water current flow.

12. The non-transitory computer readable media of claim 1, comprises one of a secure digital (SD) card, microSD card, SDHC (high capacity) card, or SDXC (extended capacity) card.

13. The non-transitory computer readable media of claim 1, wherein the water current flow simulation is generated by a processor running a hydrodynamic modeling program and using the topographical fishing map bathymetric information and selected inflow/outflow data for the body of water.

14. The non-transitory computer readable media of claim 13, wherein the hydrodynamic modeling program is Delft3D-FLOW.

15. The non-transitory computer readable media of claim 13, wherein the selected inflow/outflow data is provided by one of NOAA, monitoring stations, or user input.

16. The non-transitory computer readable media of claim 1, wherein the water current flow simulation is generated by a processor running a tidal modeling program and using the topographical fishing map bathymetric information and selected time data for the body of water.

17. The non-transitory computer readable media of claim 16, wherein the tidal modeling program is OTIS.

18. The non-transitory computer readable media of claim 1, comprises internal memory of the fish finder.

19. The non-transitory computer readable media of claim 1, wherein the water current flow simulation is stored as a separate layer from the bathymetric information of the topographical fishing map that may be turned on or off by the user input.

20. The non-transitory computer readable media of claim 1, wherein the water current flow simulation is integrated with the bathymetric information of the topographical fishing map.

21. The non-transitory computer readable media of claim 1, wherein the water current flow simulation is stored on a first non-transitory computer readable media portion, and wherein the bathymetric information of the topographical fishing map is stored on a second non-transitory computer readable media portion.

22. The non-transitory computer readable media of claim 21, wherein the first non-transitory computer readable media portion is one of a secure digital (SD) card, microSD card, SDHC (high capacity) card, or SDXC (extended capacity) card, and wherein the second non-transitory computer readable media portion is internal memory of the fish finder.

23. A method of making a non-transitory computer readable media having stored thereon data readable by a fish finder having a display and user input, the data including a topographical fishing map usable by the fish finder to display bathymetric information regarding a body of water, and at least one water current flow simulation selectable via the user input and usable by the fish finder to display water current flow on the bathymetric information regarding a body of water, comprising the steps of:
inputting the bathymetric information regarding the body of water from the topographical fishing map to a processor;
inputting at least one current flow condition to the processor;
processing, by the processor, a hydrodynamic modeling program to generate the at least one water current flow simulation corresponding to the at least one current flow condition; and
storing the at least one water current flow simulation on the non-transitory computer readable media on which the topographical fishing map is stored.

24. The method of claim 23, wherein the step of storing comprises storing the at least one water current flow simulation as a user selectable layer.

25. The method of claim 23, wherein the processor is a processor of the fish finder.

26. The method of claim 25, wherein the step of processing occurs in real time as the step of inputting the bathymetric information regarding the body of water occurs.

27. A method of making a non-transitory computer readable media having stored thereon data readable by a fish finder having a display and user input, the data including a topographical fishing map usable by the fish finder to display bathymetric information regarding a body of water, and at least one water current flow simulation selectable via the user input and usable by the fish finder to display water current flow on the bathymetric information regarding a body of water, comprising the steps of:
inputting the bathymetric information regarding the body of water from the topographical fishing map to a processor;
inputting at least one time condition to the processor;
processing, by the processor, a tidal current modeling program to generate the at least one water current flow simulations corresponding to the time condition; and
storing the plurality of water current flow simulations as user selectable layers on the non-transitory computer readable media on which the topographical fishing map is stored.

28. The method of claim 27, wherein the step of storing comprises storing the at least one water current flow simulation as a user selectable layer.

29. The method of claim 27, wherein the processor is a processor of the fish finder.

30. The method of claim 29, wherein the step of processing occurs in real time as the step of inputting the bathymetric information regarding the body of water occurs.

31. A method, comprising the steps of:
obtaining a topographical fishing map usable by the fish finder to display bathymetric information regarding a body of water to a user;
obtaining a water current flow simulation for the body of water;
displaying by the fish finder water current flow from the water current flow simulation on the bathymetric information from the topographical fishing map regarding the body of water.

32. The method of claim 31, wherein the step of obtaining the topographical fishing map comprises the step of obtaining the topographical fishing map from a non-transitory computer readable media having stored thereon the topographical fishing map.

33. The method of claim 31, wherein the step of obtaining the topographical fishing map comprises the step of generating the topographical fishing map in real time as a user vessel traverses the body of water.

34. The method of claim 31, wherein the step of obtaining the topographical fishing map comprises the step of streaming the topographical fishing map from an external source.

35. The method of claim 31, wherein the step of obtaining the topographical fishing map comprises the step of downloading the topographical fishing map from an external source.

36. The method of claim 31, wherein the step of obtaining the water current flow simulation comprises the step of obtaining the current flow simulation from a non-transitory computer readable media having stored thereon the current flow simulation.

37. The method of claim 36, wherein the step of obtaining the current flow simulation from a non-transitory computer readable media having stored thereon the current flow simulation, comprises the step of selecting the current flow simulation from a plurality of current flow simulations for different conditions stored on the non-transitory computer readable media.

38. The method of claim 31, wherein the step of obtaining the water current flow simulation comprises the step of generating the water current flow simulation in real time.

39. The method of claim 31, wherein the step of obtaining the water current flow simulation comprises the step of streaming the water current flow simulation from an external source.

40. The method of claim 31, wherein the step of obtaining the water current flow simulation comprises the step of downloading the water current flow simulation from an external source.

41. The method of claim 31, wherein the water current flow simulation includes data regarding at least one of current flow magnitude, speed, direction, and eddies for corresponding areas of the topographical fishing map, further comprising the steps of:
integrating the at least one of current flow magnitude, speed, direction, and eddies of the water current flow simulation for corresponding areas of the topographical fishing map into a predictive fishing program;
searching by the predictive fishing program for other areas of the topographical fishing map that have similar at least one of current flow magnitude, speed, direction, and eddies of the water current flow simulation for the corresponding areas of the topographical fishing map; and
highlighting the other areas on the fish finder.

42. The method of claim 41, wherein the step of searching comprises the steps of:
performing a plurality of search radii from each current vector or grid cell of the topographical fishing map in which a fish was caught that have similar at least one current flow magnitude, speed, direction, and eddies of the water current flow simulation for the corresponding areas of the topographical fishing map;
identifying another vector or grid cell of the topographical fishing map that has similar at least one current flow magnitude, speed, direction, and eddies of the water current flow simulation for the corresponding areas of the topographical fishing map in which the fish was caught;
using as a variable in the predictive fishing program information regarding the other vector or grid cell to determine a likelihood of a fish similar to the fish that was caught being present in the other vector or grid cell;
identifying likely locations on the topographical fishing map for the similar fish to be found.
